(19) United States
(12) Patent Application Publication
(10) Pub. No.: US 2025/0305417 A1
(43) Pub. Date: Oct. 2, 2025

(54) GAS TURBINE CORE TIE ROD WITH REDUCED SPAN

(71) Applicant: General Electric Company, Schenectady, NY (US)

(72) Inventors: Ramesh Balla, Bengaluru (IN); Bhaskar Nanda Mondal, Bangalore (IN); Thomas O. Moniz, Mason, OH (US)

(73) Assignee: General Electric Company, Schenectady, NY (US)

(21) Appl. No.: 18/618,454

(22) Filed: Mar. 27, 2024

(51) Int. Cl. F01D 5/06

(52) U.S. Cl. CPC F01D 5/066; F05D 2260/31

(57) ABSTRACT

Structures for achieving reduced span of tie rods and improved vibration mode margins in gas turbine engines are described. The gas turbine engine includes a tie rod assembly, a plurality of coupling nuts, a forward shaft, a blisk, a thread engagement coupled to a cone shaft of the blisk, a high pressure compressor rotor, and a high pressure turbine rotor comprising a cone shaft. A first coupling nut is coupled to the cone shaft of the high pressure compressor rotor. A second coupling nut is coupled to the forward shaft. A third coupling nut is coupled to an aft end stage of the high pressure turbine rotor.

### FIELD

The present disclosure relates to gas turbine engines, and more specifically, to gas turbine engines including a tie rod assembly with reduced span.

### BACKGROUND

A gas turbine engine for commercial aircraft typically includes a fan and a turbomachine. The turbomachine, which is commonly referred to as the core, generally includes a compressor section, a combustion section, and a turbine section in serial flow arrangement. The compressor section compresses air that is channeled to the combustion section where it is mixed with fuel. The mixture is then ignited for generating hot combustion gases. The combustion gases are channeled to the turbine section which extracts energy from the combustion gases for powering the compressor section, as well as for producing work, such as for propulsion of an aircraft in flight, or for powering a machine such as an electrical generator.

Current tie rod architectures, including increasing the diameter of the tie rod, may improve vibration mode margin. However, there are limitations on how much additional weight the tie rod can be, as well as on the rotor.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of a gas turbine engine according to one or more aspects described and illustrated herein;

FIG. 2A schematically depicts a plurality of stages of a compressor of the gas turbine engine of FIG. 1 according to one or more aspects described and illustrated herein;

FIG. 2B schematically depicts a detailed view of a portion of the stages of the compressor of FIG. 2A and a portion of a combustion section of the gas turbine engine, according to one or more aspects described and illustrated herein;

FIG. 3A schematically depicts a cross-sectional view of the gas turbine engine of FIG. 1 including a tie rod, according to one or more aspects described and illustrated herein;

FIG. 3B schematically depicts a portion of the cross-sectional view of the gas turbine engine of FIG. 3A, according to one or more aspects described and illustrated herein;

FIG. 4A schematically depicts a cross-sectional view of the gas turbine engine of FIG. 3A including an integral forward shaft with a blisk, according to one or more aspects described and illustrated herein;

FIG. 4B schematically depicts a portion of the cross-sectional view of the gas turbine engine of FIG. 4A, according to one or more aspects described and illustrated herein;

FIG. 5A schematically depicts a cross-sectional view of the gas turbine engine of FIG. 3A including an integral forward shaft with a tie rod, according to one or more aspects described and illustrated herein;

FIG. 5B schematically depicts a portion of the cross-sectional view of the gas turbine engine of FIG. 5A, according to one or more aspects described and illustrated herein; and

FIG. 6 schematically depicts a cross-sectional view of the gas turbine engine of FIG. 3A including a tie rod welded with a blisk, according to one or more aspects described and illustrated herein.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

The terms “forward” and “aft” refer to relative positions within a gas turbine engine, pump, or vehicle, and refer to the normal operational attitude of the gas turbine engine, pump, or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction toward which the fluid flows.

As used in this application, stating that any part (e.g., an area) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Some types of tie rod architectures may include a configuration that has a tie rod and a hat spring. The hat spring may be configured to provide mid-span support to improve vibration mode margins. The hat spring has a split at one location and induces radial asymmetric load that causes operational issues, such as rotor imbalance and rotor vibration during operation. Thus, these types of tie rod architectures can be configured to include a tie rod with its both ends thickened to improve vibration mode margins without the presence of the hat spring.

Still further, other types of tie rod architectures may include a configuration that has a tie rod with higher length/diameter (L/D) ratio, as compared to the above-identified types of tie rod architectures. This higher L/D ratio reduces the tie rod vibration mode margin lower than the 20% margin requirement at a core redline speed. The option to use thickened ends of the tie rod, as with the above-identified types of tie rod architectures, does not improve vibration mode margins, and thus mid-span support is necessary.

While some approaches to improve vibration mode margin include increasing the tie rod diameter, doing so leads to additional weight on not only the tie rod, but also on the whole rotor of high pressure compressor rotor/high pressure turbine rotor, or increasing the axial span of the last stages, such as the plurality of compressor stages, of the high pressure compressor rotor to accommodate weld cleaning.

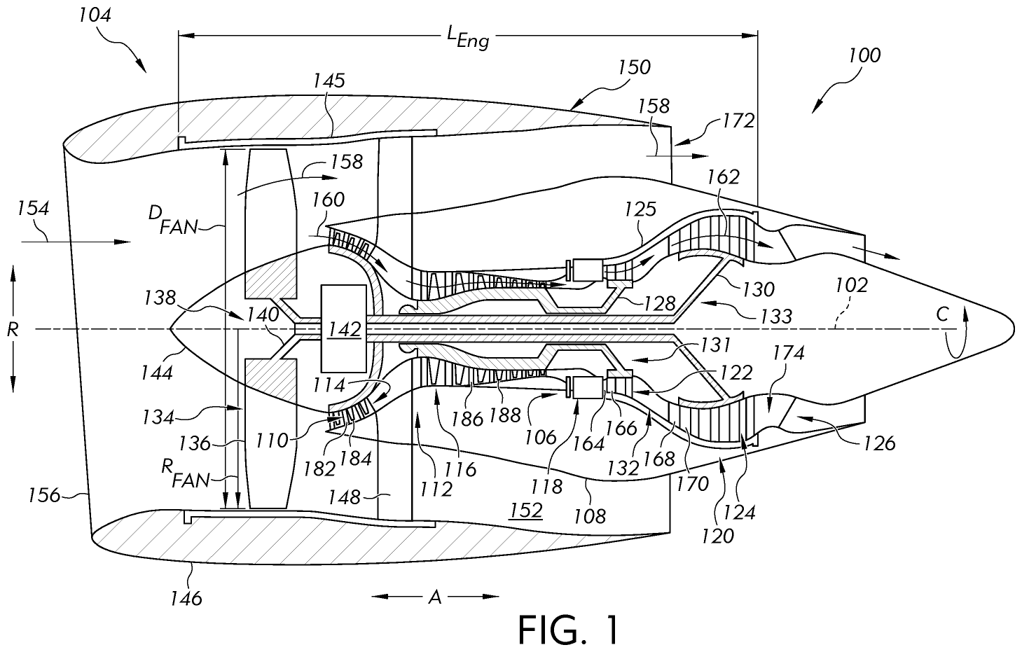

Referring now to the drawings, FIG. 1 provides a schematic cross-sectional view of a turbofan engine 100 according to an example embodiment of the present disclosure. For the depicted embodiment of FIG. 1, the turbofan engine 100 is an aeronautical, high-bypass turbofan engine configured mountable to an aircraft, such as, for example, in an under-wing configuration. As shown, the turbofan engine 100 defines an axial direction A, a radial direction R, and a circumferential direction C. The axial direction A extends parallel to or coaxial with a longitudinal centerline 102 defined by the turbofan engine 100.

The turbofan engine 100 includes a fan section 104 and a core turbine engine 106 disposed downstream of the fan section 104. The core turbine engine 106 includes an engine cowl 108 that defines an annular core inlet 110. The engine cowl 108 encases, in a serial flow relationship, a compressor section 112 including a first booster (e.g., an LP compressor 114) and a second booster (e.g., an HP compressor 116), a combustion section 118, a turbine section 120 including a first turbine (e.g., an HP turbine 122) and a second turbine (e.g., an LP turbine 124), and an exhaust section 126. The compressor section 112, combustion section 118, turbine section 120, and exhaust section 126 together define a core air flowpath 132 through the core turbine engine 106.

An HP shaft 128 drivingly connects the HP turbine 122 to the HP compressor 116. An LP shaft 130 drivingly connects the LP turbine 124 to the LP compressor 114. The HP shaft 128, the rotating components of the HP compressor 116 that are mechanically coupled with the HP shaft 128, and the rotating components of the HP turbine 122 that are mechanically coupled with the HP shaft 128 collectively form a high pressure spool, or HP spool 131. The LP shaft 130, the rotating components of the LP compressor 114 that are mechanically coupled with the LP shaft 130, and the rotating components of the LP turbine 124 that are mechanically coupled with the LP shaft 130 collectively form a low pressure spool, or LP spool 133.

The fan section 104 includes a fan assembly 138 having a fan 134 mechanically coupled with a fan rotor 140. The fan 134 has a plurality of fan blades 136 circumferentially-spaced apart from one another. As depicted, the fan blades 136 extend outward from the fan rotor 140 along the radial direction R. A power gearbox 142 mechanically couples the LP spool 133 and the fan rotor 140. The power gearbox 142 may also be called a main gearbox. The power gearbox 142 includes a plurality of gears for stepping down the rotational speed of the LP shaft 130 to provide a more efficient rotational fan speed of the fan 134. In other example embodiments, the fan blades 136 of the fan 134 can be mechanically coupled with a suitable actuation member configured to pitch the fan blades 136 about respective pitch axes, such as, for example, in unison. In some alternative embodiments, the turbofan engine 100 does not include the power gearbox 142. In such alternative embodiments, the fan 134 can be directly mechanically coupled with the LP shaft 130, such as, for example, in a direct drive configuration.

Referring still to FIG. 1, the fan rotor 140 and hubs of the fan blades 136 are covered by a rotatable spinner 144 aerodynamically contoured to promote an airflow through the plurality of fan blades 136. Additionally, the fan section 104 includes an annular fan casing 145 and an outer nacelle 146 connected to the fan casing 145. The fan casing 145 and the outer nacelle 146 both circumferentially surround the fan 134 and/or at least a portion of the core turbine engine 106. The fan casing 145 and the outer nacelle 146 are supported relative to the core turbine engine 106 by a plurality of circumferentially-spaced outlet guide vanes 148. A downstream section 150 of the nacelle 146 extends over an outer portion of the core turbine engine 106 so as to define a bypass passage 152 therebetween.

During operation of the turbofan engine 100, a volume of air 154 enters the turbofan engine 100 through an associated inlet 156 of the nacelle 146 and/or fan section 104. As the volume of air 154 passes across the fan blades 136, a first portion of air 158 is directed or routed into the bypass passage 152 and a second portion of air 160 is directed or routed into the annular core inlet 110. The pressure of the second portion of air 160 is progressively increased as it flows downstream through the LP compressor 114 and HP compressor 116. Particularly, the LP compressor 114 includes sequential stages of LP compressor stator vanes 182 and LP compressor blades 184 that progressively compress the second portion of air 160. The LP compressor blades 184 are mechanically coupled to the LP shaft 130. Similarly, the HP compressor 116 includes sequential stages of HP compressor vanes 186 and HP compressor blades 188 that progressively compress the second portion of air 160 even further. The HP compressor blades 188 are mechanically coupled to the HP shaft 128. Additional details regarding the various components of the LP compressor 114 and the HP compressor 116 will be described in greater detail hereinbelow. The compressed second portion of air 160 is then discharged from the compressor section 112 into the combustion section 118.

The compressed second portion of air 160 discharged from the compressor section 112 mixes with fuel and is burned within a combustor of the combustion section 118 to provide combustion gases 162. The combustion gases 162 are routed from the combustion section 118 along a hot gas path 174 of the core air flowpath 132 through the HP turbine 122 where a portion of thermal and/or kinetic energy from the combustion gases 162 is extracted via sequential stages of HP turbine stator vanes 164 and HP turbine blades 166. The HP turbine blades 166 are mechanically coupled to the HP shaft 128. Thus, when the HP turbine blades 166 extract energy from the combustion gases 162, the HP shaft 128 rotates, which supports operation of the HP compressor 116. The combustion gases 162 are routed through the LP turbine 124 where a second portion of thermal and kinetic energy is extracted from the combustion gases 162 via sequential stages of LP turbine stator vanes 168 and LP turbine blades 170. The LP turbine blades 170 are coupled to the LP shaft 130. Thus, when the LP turbine blades 170 extract energy from the combustion gases 162, the LP shaft 130 rotates and supports operation of the LP compressor 114, as well as the fan 134 by way of the power gearbox 142.

The combustion gases 162 exit the LP turbine 124 and are exhausted from the core turbine engine 106 through the exhaust section 126 to provide propulsive thrust. Simultaneously, the pressure of the first portion of air 158 is substantially increased as the first portion of air 158 is routed through the bypass passage 152 before the first portion of air 158 is exhausted from a fan nozzle exhaust section 172 of the turbofan engine 100, also providing propulsive thrust. The HP turbine 122, the LP turbine 124, and the exhaust section 126 at least partially define the hot gas path 174.

It will be appreciated that the turbofan engine 100 depicted in FIG. 1 is provided by way of example, and that in other example embodiments, the turbofan engine 100 has other configurations. Additionally, or alternatively, aspects of the present disclosure may be utilized with other suitable aeronautical turbofan engines, a turboshaft engine, and turboprop engine.

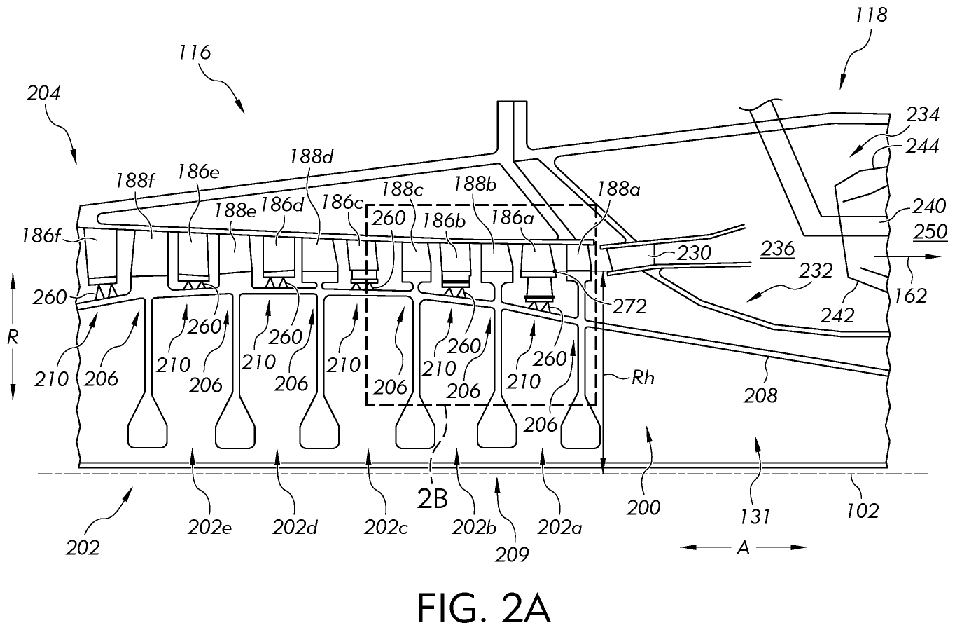

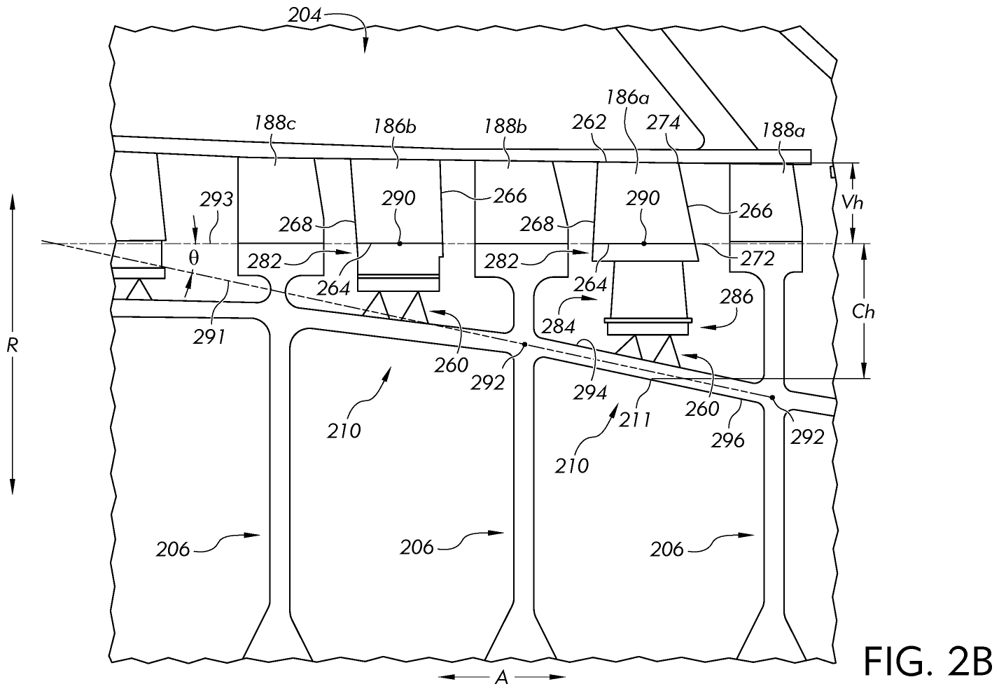

Referring now to FIG. 2A, a schematic, cross-sectional view of a portion of the compressor section 112 and a portion of the combustion section 118 of the turbofan engine 100 of FIG. 1 is provided. More specifically, FIG. 2A depicts an aft end of the HP compressor 116 of the compressor section 112 and a portion of the combustion section 118. However, it should be appreciated that the various components described herein can be included in other compressor sections of the turbofan engine 100, including the LP compressor 114 and/or an intermediate pressure (IP) compressor in 3 spool gas turbine engines.

Referring to FIGS. 1 and 2A-2B, and as noted above, during operation of the turbofan engine 100, an airflow through the core air flowpath 132 of the turbofan engine 100 is sequentially compressed as it flows through the compressor section 112, or more specifically, as it flows through the LP compressor 114 and the HP compressor 116. The compressed air from the compressor section 112 is then provided to the combustion section 118, wherein at least a portion of the compressed air is mixed with fuel and burned to create the combustion gases 162. The combustion gases 162 flow from the combustion section 118 to the turbine section 120, and more specifically, sequentially through the HP turbine 122 and the LP turbine 124, for the embodiment depicted, driving the HP turbine 122 and the LP turbine 124. The HP spool 131 is drivingly coupled to both the HP turbine 122 and the HP compressor 116.

Referring particularly to FIG. 2A, the HP compressor 116 includes a plurality of compressor stages 202a-202e (collectively, compressor stages 202), with each of the compressor stages 202 including, for example, a plurality of the HP compressor blades 188 and a rotor 206. While five compressor stages 202 are depicted in FIG. 2A, the HP compressor 116 includes greater than or fewer than five stages in other embodiments. Each of the various compressor stages 202 is drivingly coupled to the HP spool 131, such that the HP turbine 122 (FIG. 1) may drive the HP compressor 116 through the HP spool 131. Amongst the plurality of compressor stages 202 of HP compressor 116, is an aft-most stage 202a located at an aft end 200 of the HP compressor 116.

The aft-most stage 202a provides compressed air to the combustion section 118. More specifically, for the embodiment depicted in FIG. 2A, the combustion section 118 includes a diffuser 230, an inner combustor casing 232, and a combustor assembly 234. Further, the combustion section 118 defines a diffuser cavity 236, with the diffuser 230 located downstream of the compressor stages 202 of the HP compressor 116 and upstream of the diffuser cavity 236, such that compressed air from the aft-most stage 202a is provided to the diffuser cavity 236 through the diffuser 230. The compressed air within the diffuser cavity 236 is, in turn, provided to the combustor assembly 234, where the compressed air is mixed with fuel and burned to generate the combustion gases 162. As is depicted in FIG. 2A, the combustor assembly 234 generally includes a fuel nozzle 240, an inner liner 242, and an outer liner 244, with the inner liner 242 and the outer liner 244 together forming a combustion chamber 250.

It should be appreciated that the combustor assembly 234 is configured as a suitable assembly for the turbofan engine 100 (FIG. 1). For example, in certain embodiments, the combustor assembly 234 is configured as an annular combustor assembly, a can combustor assembly, or a cannular combustor assembly.

Referring still to FIG. 2A, as previously noted, the HP spool 131 is drivingly connected to the HP compressor 116. For the embodiment depicted, the HP spool 131 generally includes a central spool section including a central spool member 208, which may also be referred to herein as an inner circumferential support structure. The central spool member 208 extends, for the embodiment depicted in FIG. 2A, generally along the axial direction A at a location radially inward of the combustor assembly 234 of the combustion section 118. In addition, the central spool member 208 is coupled to or formed integrally with one or more spacer arms 210 located forward of the central spool member 208. The one or more spacer arms 210, for the embodiment depicted, also extend generally along the axial direction A. Together, the central spool member 208 and the one or more spacer arms 210 may form an inner circumferential support structure 209 of the HP compressor 116.

Still referring to FIG. 2A, the aft-most stage 202a of the HP compressor 116 represents a final stage of the HP compressor 116 when traversing the HP compressor 116 from fore to aft positions in the axial direction A. One or more forward stages 202b-202e located forward of the aft-most stage 202a include, for example, a first forward stage 202b, a second forward stage 202c, a third forward stage 202d, and a fourth forward stage 202e. Each one of the compressor stages 202a-202f includes corresponding ones of the HP compressor vanes 186 and the HP compressor blades 188. That is, the aft-most stage 202a includes an aft-most vane 186a (e.g., a first vane) and a first compressor blade 188a, the first forward stage 202b includes a second vane 186b and a second compressor blade 188b, the second forward stage 202c includes a third vane 186c and a third compressor blade 188c, the third forward stage 202d includes a fourth vane 186d and a fourth compressor blade 188d, and the fourth forward stage 202e includes a fifth vane 186e and a fifth compressor blade 188e, and so forth (e.g., a sixth vane 186f and a sixth compressor blade 188f, etc.).

The HP compressor 116 further includes an outer casing 204, which may also be referred to herein as an outer circumferential support structure. The outer casing 204 may extend generally in the axial direction A radially outward of the inner circumferential support structure 209. In some embodiments, the outer casing 204 and the inner circumferential support structure 209 are positioned around a central axis, such as, for example, the longitudinal centerline 102 of the turbofan engine 100 (FIG. 1). That is, the inner circumferential support structure 209 is positioned radially outward of the longitudinal centerline 102 (FIG. 1), and the outer casing 204 is spaced radially outward of the inner circumferential support structure 209, as depicted in FIG. 2A.

Referring to FIGS. 2A and 2B, the various vanes 186 of the compressor generally extend inwardly a distance in the radial direction R from the outer casing 204. Each one of the various vanes 186 extends from the outer casing 204 at a location that is between adjacent compressor blades 188. For example, the aft-most vane 186a may extend from the outer casing 204 at a location that is between the first compressor blade 188a and the second compressor blade 188b. In addition, the various vanes 186 extend towards the inner circumferential support structure 209, particularly one of the one or more spacer arms 210 thereof. In embodiments, one or more components are disposed between the vanes 186 and the corresponding spacer arms 210, such as, for example, an inner platform 282, a seal support structure 284, a seal structure 286, and/or one or more seal teeth 260, as described in greater detail herein.

Referring particularly to FIG. 2B, which schematically depicts an enlarged view of a portion 2B in FIG. 2A, each of the vanes 186 (e.g., the aft-most vane 186a, the second vane 186b, etc.) includes a root 262, a tip 264, a leading edge 268, and a trailing edge 266. The root 262 of each vane 186 represents a radially outward extent of the vane 186 at a connection point with the outer casing 204. That is, the root 262 of each vane 186 is the part (e.g., end) of the vane 186 that contacts the outer casing 204. The tip 264 of each vane 186 represents a radially inward extent of the vane 186. That is, the tip 264 of each vane 186 is the part (e.g., end) of the vane that is closest to the corresponding spacer arm 210. The leading edge 268 of each vane 186 represents an edge of the vane 186 that extends from the root 262 to the tip 264 and is a forward-most edge of the vane 186 generally in the axial direction (e.g., an edge that receives fluid flowing through the HP compressor 116, as described herein). The trailing edge 266 of each vane 186 represents an edge of the vane 186 that extends from the root 262 to the tip 264 and is an aft-most edge of the vane 186 generally in the axial direction. As such, the trailing edge 266 and the leading edge 268 are opposite one another. In some embodiments, the trailing edge 266 and the leading edge 268 are parallel or substantially parallel to one another. In other embodiments, the trailing edge 266 and the leading edge 268 are not parallel to one another.

As depicted in FIG. 2B, each of the vanes 186 defines a first point 272 and a second point 274. The first point 272 represents the intersection of the tip 264 of the vane 186 with the trailing edge 266 of the vane 186. The second point 274 represents an intersection of the root 262 of the vane 186 with the trailing edge 266 of the vane 186.

As noted herein, one or more components may be disposed between the tip 264 of each vane 186 and the corresponding spacer arm 210, including, for example, the inner platform 282, the seal support structure 284, the seal structure 286, and/or the one or more seal teeth 260. In embodiments, the inner platform 282, the seal support structure 284, the seal structure 286, and the one or more seal teeth 260 appear in serial order from the tip 264 to the corresponding spacer arm 210, with the inner platform 282, the seal support structure 284, and the seal structure 286 coupled to one another and the tip 264 of each vane 186 and the one or more seal teeth disposed on a radially outer surface 294 of the spacer arm 210.

The inner platform 282 is a component that defines a flow path. That is, fluid (e.g., air) movement through each of the compressor stages 202 (FIG. 2A) occurs via the flow path defined by the inner platform 282. The inner platform 282 is coupled to and extends inward along the radial direction R from the tip 264 of the vane 186. As will be appreciated, the inner platform 282 has a shape and surface features that are not necessarily limited to the shape and surface features disclosed in the examples. For example, the inner platform 282 may be shaped to correspond to a shape of the tip 264 of the vane 186 and/or may be shaped to flare outward in the axial direction A relative to a width of the vane 186 (e.g., a dimension extending from the leading edge 268 to the trailing edge 266 of the vane 186). Each inner platform 282 may be different relative to the other inner platforms 282 in shape, size, and configuration, or may be substantially the same as the other inner platforms 282 in shape, size, and configuration.

The inner platform 282 further defines an area past which air of the core air flowpath 132 (FIG. 1) flows. The specific dimensional aspects of the inner platform 282, as described in greater detail herein, directs the air from the core air flowpath 132 (FIG. 1) in a particular manner. While the flowpath hub is still maintained, an angle of a high-pressure aft cone arm reduces with respect to the longitudinal centerline 102 (FIG. 1), which enables better life for various components.

The seal support structure 284 is generally a component coupled to and disposed inward in the radial direction R of the inner platform 282. The seal support structure supports the seal structure 286 thereon. The seal structure 286 is generally any component that prevents or minimizes fluid leakage from the flow path defined by the inner platform 282. That is, the seal structure 286 functions to maintain fluid flow within the flow path defined by the inner platform 282. In the embodiment depicted in FIG. 2B, the seal structure 286 is an abradable honeycomb seal. That is, the seal structure 286 is a machined component having individual chambers that create a pressure drop to slow leakage and/or disrupt circumferential flow around the HP shaft 128 (FIG. 1). The seal structure 286 forms a seal with the seal teeth 260 that are disposed on the radially outer surface 294 of the spacer arm 210.

It should be appreciated that the seal structure 286 depicted in FIG. 2B is not limited to an abradable honeycomb seal. For example, in other embodiments, the seal structure 286 is a bridge seal, a stick-type seal, a box-type seal, an attached seal ring housing, a foil seal, a brush seal, an advanced aspirating seal, or the like. In some embodiments, the seal structure 286 is selected depending on the size of an inter stage seal (ISS) cavity defined by the spacer arm 210, adjacent rotors 206 and the outer casing 204.

Referring again to FIGS. 2A and 2B, the spacer arms 210 are generally positioned a distance inward from the outer casing 204 in the radial direction R to define spaces for each of the compressor stages 202, including the vanes 186 and the HP compressor blades 188 thereof. The spacer arm 210 of the aft-most stage 202a defines-points 292 that are centrally located at an intersection of the spacer arm 210 with each rotor 206 bounding the aft-most stage 202a. As will be described in greater detail herein, a first line 291 drawn through both points 292 forms an angle θ with a second line 293 that is parallel to the longitudinal centerline 102 (e.g., in some embodiments, extending through at least one midpoint 290 located equidistant from the trailing edge 266 and the leading edge 268 at the root 262 of a vane 186). The angle θ may be referred to as a spacer angle. It should be understood that since each spacer arm 210 may have a different slope, each compressor stage 202 may have a corresponding spacer angle that is different from a spacer angle of an adjacent or nearby spacer arm. As such, the angle θ depicted in FIG. 2B is referred to as the spacer angle for the aft-most stage 202a.

As previously noted herein, the spacer arms 210 include the radially outer surface 294 and the radially inner surface 296. The radially inner surface 296 is opposite the radially outer surface 294. The radially outer surface 294 of the spacer arms 210 generally faces the vanes 186 and, in some embodiments, supports the one or more seal teeth 260 coupled thereto. The spacer arms 210 generally define a thickness in the radial direction R between the radially outer surface 294 and the radially inner surface 296. In addition, the spacer arms 210 define a midpoint 211 on the radially inner surface 296 that is located equidistant between adjacent points 292, as depicted in FIG. 2B.

As will be described in further detail herein, a first radial distance Ch is defined by a distance in the radial direction R between the first point 272 and the midpoint 211 on the radially inner surface 296 of the corresponding spacer arm 210. That is, the first radial distance Ch represents a distance that includes all of the components disposed between the tip 264 of the vane 186 and the corresponding spacer arm 210, including, in some examples, the inner platform 282, the seal support structure 284, the seal structure 286, the one or more seal teeth 260, and the thickness of the spacer arm 210. This first radial distance Ch may also be referred to as a cavity height. As will also be described in further detail herein, a second radial distance Vh is defined by a distance in the radial direction R between the first point 272 and the second point 274. The second radial distance Vh also represents a height of the vane 186 and may be referred to as a vane height. Further, with reference to FIG. 2A, a third radial distance Rh is defined by a distance in the radial direction R between the first point 272 and the longitudinal centerline 102 of the engine.

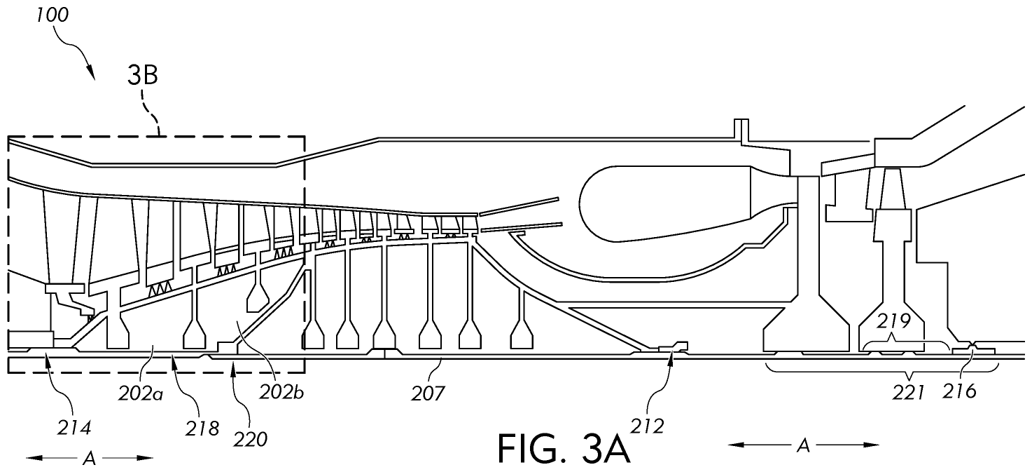

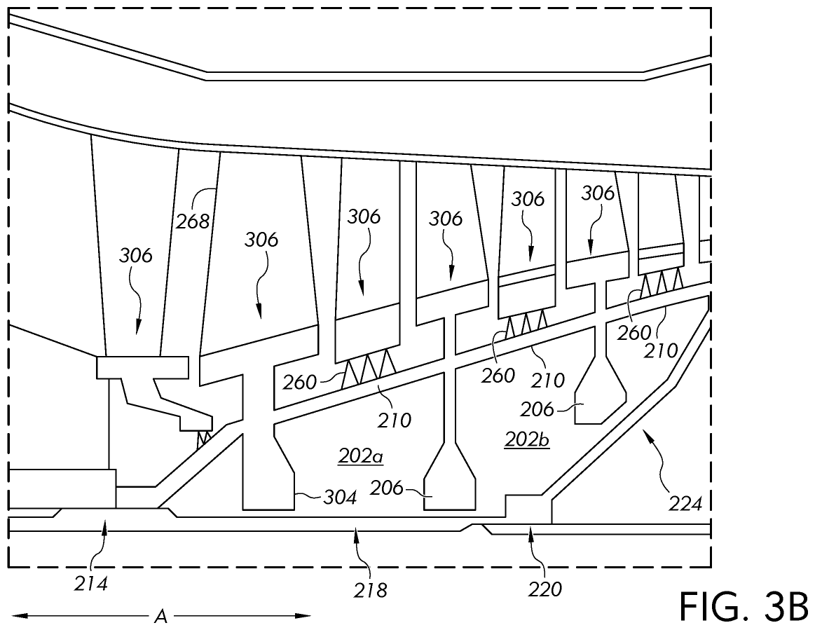

Referring now to FIG. 3A, another cross-sectional view of the turbofan engine 100 including a tie rod 207 of FIG. 1 is depicted. The turbofan engine 100 may include a plurality of compressor stages 202 (such as plurality of compressor stages 202a-202h), a plurality of rotors 206, a plurality of spacer arms 210, a blisk 304, one or more seal teeth 260, and a plurality of airfoils 306, such as one or more vanes 186 each including a leading edge 268. FIG. 3A further depicts a first nut 212, a second nut 214, a third nut 216, a forward shaft 218, and a thread engagement 220. FIG. 3A may reference and incorporate any constituent components of the turbofan engine 100 as explained above with respect to FIG. 1 and FIGS. 2A-2B. Although single instances of the components are depicted of the turbofan engine 100 of FIG. 3A, it is understood that any number of components may be included.

The dashed box 3B in FIG. 3A corresponds to FIG. 3B. In some examples, the thread engagement 220 may be configured to engage internal threads of the forward shaft 218 with external threads of the tie rod 207. In some examples, the thread engagement 220 may be directly coupled to the tie rod 207 without any intervening parts. In other examples, the thread engagement 220 may be indirectly coupled to the tie rod 207, such as via one or more intervening parts. For example, splitting the tie rod 207 into three or more loops with the forward shaft 218 enables reduction of an unsupported length of the tie rod 207 that helps to improve the tie rod vibration mode margin for a first bending mode. For example, splitting the tie rod 207 into a three loop configuration includes the first nut 212 on a high pressure compressor rotor cone shaft and thread engagement 220 to a blisk 304, such as a cone shaft 224 of the blisk, the second nut 214 on the forward shaft 218, and the third nut 216 at an aft end of the high pressure turbine rotor. In some examples, each of the first nut 212, the second nut 214, and the third nut 216 may include a coupling nut. By way of example, the coupling nut may be circumferentially shaped but is not limited to such a configuration. The forward shaft 218, which may include IN718 alloy and may be configured to improve low cycle fatigue at thread fillets.

The splitting of a high pressure tie rod rotor assembly, such as the tie rod 207, into a plurality of clamp loops, for example, three loops, with a forward shaft 218 connection with a blisk 304 shortens the tie rod effective span. This splitting helps to reduce the tie rod 207 L/D ratio, which improves the vibration mode margin. In addition, the splitting provides a higher interface load and higher torque carrying capability for the turbofan engine 100, and reduction in high pressure span, leading to improved high pressure, low pressure dynamics. Still further, a particularly designed forward shaft is configured to improve low cycle fatigue at thread fillets. Moreover, the blisk 304, such as a high pressure compressor blisk, may be replaced without disassembly of the core rotor.

Splitting the tie rod 207 in a high pressure compressor module generates higher clamp load and torque carrying capability at an aft stage 202 of the high pressure turbine rotor. This enables keeping a friction joint that leads to a reduced high pressure compressor rotor axial length. In some examples, the joint may comprise a friction joint, curvic coupling, induction welding (IW), may be bolted, or the like which may be used with a tie bolt rotor. An outer diameter of a shaft 219 of the tie rod 207 may be less than an inner diameter of the high pressure turbine rotor 221 so that the tie rod 207 passes into the core from the forward end.

At least one of the plurality of compressor stages 202 depicted in FIG. 3B includes a blisk 304. That is, the at least one of the plurality of compressor stages 202 includes a disk with integral/welded blades instead of other forms of blade to disk attachment, such as axial or circumferential dovetail, bolted, or pinned. These are different combinations/types of blade attachments that can be used interchangeably at the at least one of the plurality of compressor stages 202 or any other stage of the compressor.

In some examples, the airfoil 306 may be connected to the blisk 304. The plurality of airfoils 306 may comprise trapezoidal or trapezoidal-like shapes. However, it is understood that the plurality of airfoils 306 are not limited to such shapes, and that any shape for the plurality of airfoils may 306 be used.

The compressor of the turbofan engine 100 may include a plurality of compressor stages 202. For example, the plurality of compressor stages 202 may include ten compressor stages. However, it is understood that the plurality of compressor stages 202 are not limited to such number of compressor stages, and that any number of compressor stages 202 may be used. By way of example, a first portion (202a-202e) of the plurality of compressor stages 202 may include blisks 304, the first portion including five compressor stages. A second portion (202f-202j) may include circumferential dovetail bladed disks, the second portion including five compressor stages. It is understood that a first predetermined number of a first type of disk and a second predetermined number of a second type of disk are not limited to these types and/or numbers of disks, and that other types of disks may be used. For example, the first predetermined number of the first type of disk may be less than the second predetermined number of the second type of disk. In another example, the first predetermined number of the first type of disk may be equal to the second predetermined number of the second type of disk. In still another example, the first predetermined number of the first type of disk may be greater than the second predetermined number of the second type of disk. Further, the plurality of compressor stages 202 may be welded together.

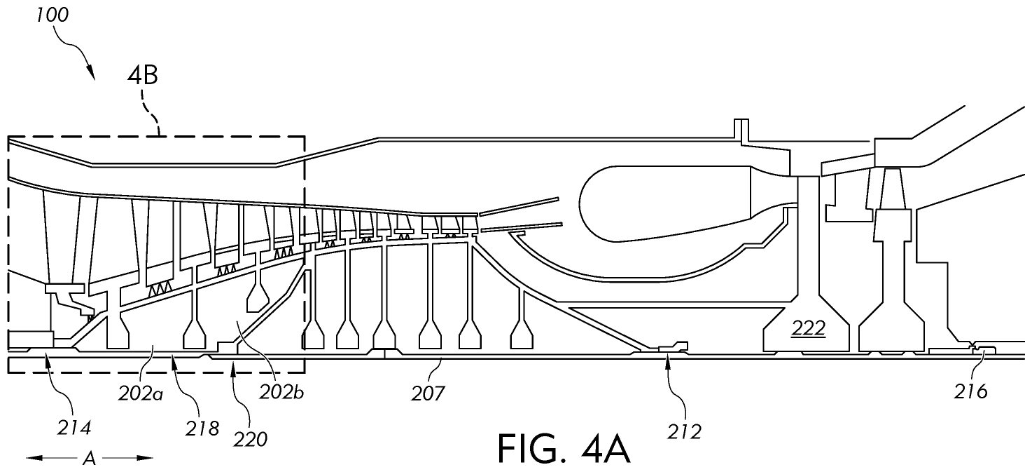

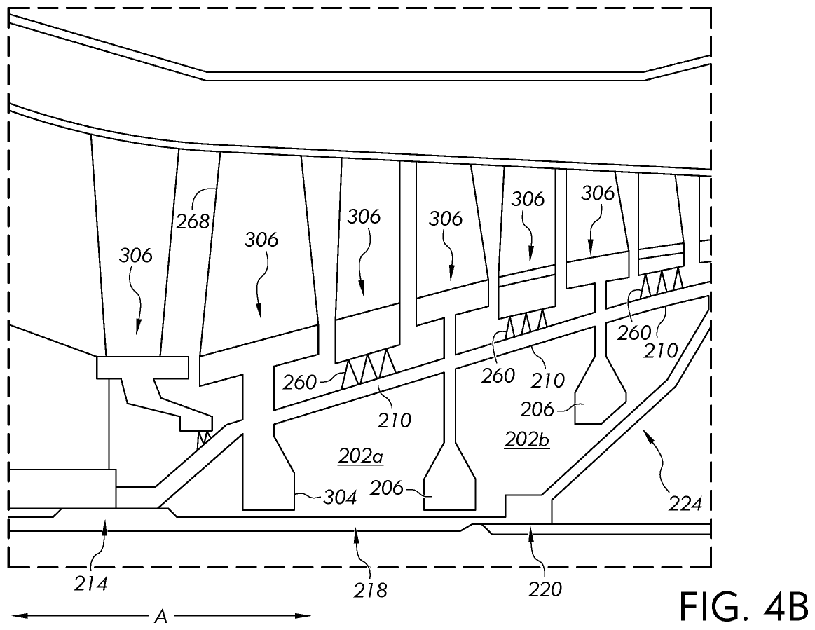

FIG. 4A schematically depicts a cross-sectional view of the turbofan engine 100 of FIG. 3A including an integral forward shaft 218 with a blisk 304. FIG. 4A may reference and incorporate any constituent components of the turbofan engine 100 as explained above with respect to FIG. 1 and FIGS. 2A-2B and FIGS. 3A-3B. Although single instances of the components are depicted of the turbofan engine 100 of FIG. 4A, it is understood that any number of components may be included. FIG. 4A depicts an integral forward shaft 218 with a blisk 304 together as a one piece, monolithic component, which in certain embodiments and without limitation, may be formed by heat application, pressure application, additive manufacturing, or any combination thereof. The dashed box 4B in FIG. 4A corresponds to FIG. 4B. The plurality of compressor stages 202 forward of a cone shaft 224 of a high pressure compressor rotor assembly use a nut, such as the second nut 214. In some examples, these plurality of compressor stages 202 may comprise a spool/friction joint configuration. In some examples, the joint may comprise a friction joint, curvic, IW, bolted, or the like which may be used with a tie bolt rotor. Moreover, all later plurality of compressor stages 202 of the high pressure compressor rotor assembly may use the thread engagement 220 into the forward shaft 218 and the first nut 212. The final assembly of the core may use the third nut 216 at an aft stage of a high pressure turbine rotor 222.

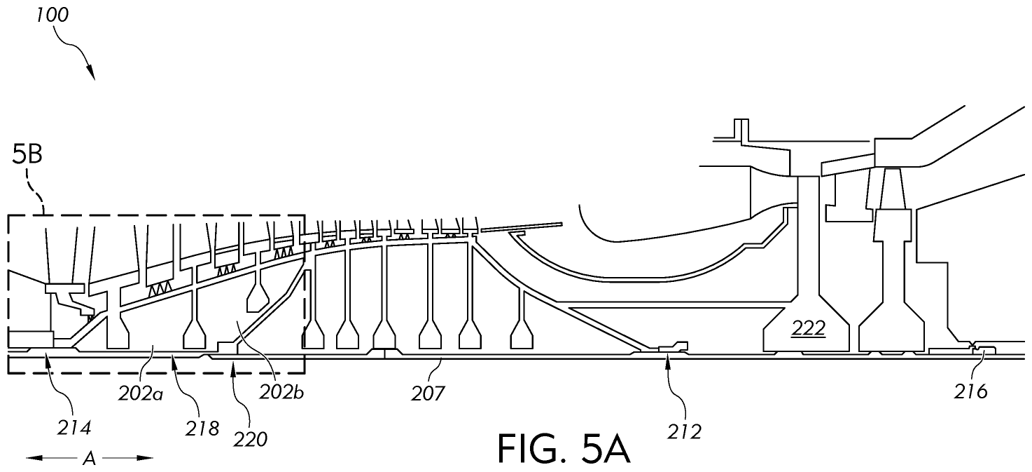

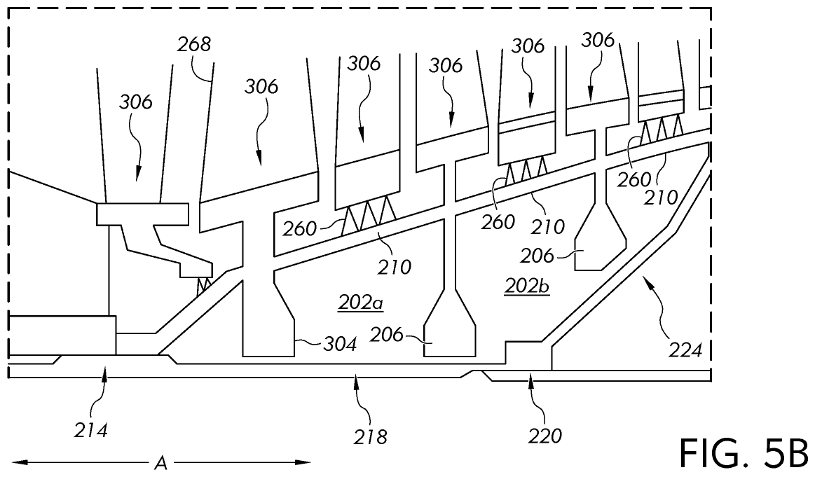

FIG. 5A schematically depicts a cross-sectional view of the turbofan engine 100 of FIG. 3A including an integral forward shaft with a tie rod. FIG. 5A may reference and incorporate any constituent components of the turbofan engine 100 as explained above with respect to FIG. 1 and FIGS. 2A-2B and FIGS. 3A-3B and FIGS. 4A-4B. Although single instances of the components are depicted of the turbofan engine 100 of FIG. 5A, it is understood that any number of components may be included. FIG. 5A depicts a forward shaft 218 and a tie rod 207 together as a one piece, monolithic component. The dashed box 5B in FIG. 5A corresponds to FIG. 5B. The integral forward shaft 218 and tie rod 207 may be configured to engage with the blisk 304 through the thread engagement 220 without tab. A buttress thread loading face on the tie rod 207 is oriented forward. The plurality of compressor stages 202 forward of a cone shaft 224 may be assembled using the second nut 214. In some examples, these plurality of compressor stages 202 may comprise a spool/friction joint configuration. In some examples, the joint may comprise a friction joint, curvic, IW, bolted, or the like which may be used with a tie bolt rotor. Moreover, all later plurality of compressor stages 202 of the high pressure compressor rotor assembly may use the first nut 212. The final assembly of the core may use the third nut 216 at an aft stage of a high pressure turbine rotor 222.

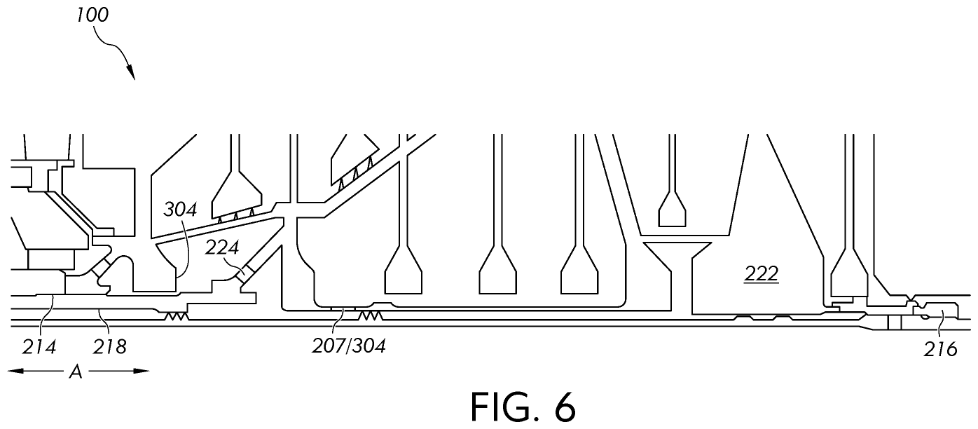

FIG. 6 schematically depicts a cross-sectional view of the turbofan engine 100 of FIG. 3A including a tie rod 207 welded with a blisk 304. FIG. 6 may reference and incorporate any constituent components of the turbofan engine 100 as explained above with respect to FIG. 1 and FIGS. 2A-2B and FIGS. 3A-3B and FIGS. 4A-4B and FIGS. 5A-5B. Although single instances of the components are depicted of the turbofan engine 100 of FIG. 6, it is understood that any number of components may be included. FIG. 6 depicts a tie rod 207 welded with a blisk 304 at a joint as a one piece component. The plurality of compressor stages 202 forward of a cone shaft 224 of a high pressure compressor rotor assembly may use the second nut 214. In some examples, these plurality of compressor stages 202 may comprise a spool/friction joint configuration. In some examples, the joint may comprise a friction joint, curvic, IW, bolted, or the like which may be used with a tie bolt rotor. Moreover, all later plurality of compressor stages 202 of the high pressure compressor rotor assembly may use the first nut 212. The final assembly of the core may use a third nut 216 at an aft stage of a high pressure turbine rotor 222.

By way of example and without limitation, the tie rod assembly may be assembled by assembling or stacking a predetermined number of the plurality of compressor stages 202 at one or more joints, such as a friction joint. The tie rod may be assembled from aft and engage with threads to one of the predetermined number of the plurality of compressor stages 202 forward shaft 218. A pull load, such as a hydraulic pull load, aft may be applied on the tie rod with push of high pressure compressor rotor and a first nut may be tightened. A second predetermined number of the plurality of compressor states 202 may be assembled or stacked at another joint, such as another friction joint. Another pull load, such as another hydraulic pull load, aft may be applied on the forward cone shaft and a second nut may be tightened. A high pressure turbine module may be assembled to a high pressure compressor rotor assembly from aft. Another pull load, such as third hydraulic pull load, aft may be applied on the tie rod and a third nut may be tightened.

From the above, it is to be appreciated that defined herein is a configuration of the splitting of a high pressure tie rod rotor assembly into a plurality of clamp loops, for example, three loops, with a forward shaft connection with a blisk that reduces the effective span of a tie rod effective span. This splitting helps to reduce the tie rod L/D ratio, which improves the vibration mode margin. In addition, the splitting provides a higher interface load and higher torque carrying capability for the turbofan engine, and reduction in high pressure span, leading to improved high pressure, low pressure dynamics. Still further, a particularly designed forward shaft is configured to improve low cycle fatigue at thread fillets. Moreover, the blisk, such as a high pressure compressor blisk, may be replaced without disassembly of the core rotor.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

Clause 1. A turbofan engine, comprising: a tie rod assembly; a plurality of coupling nuts; a forward shaft; a blisk; a thread engagement coupled to a cone shaft of the blisk; a high pressure compressor rotor; and a high pressure turbine rotor comprising a cone shaft, wherein a first coupling nut is coupled to the cone shaft of the high pressure compressor rotor, a second coupling nut is coupled to the forward shaft, and a third coupling nut is coupled to an aft end stage of the high pressure turbine rotor.

Clause 2. The turbofan engine according to the previous clause, wherein the thread engagement is configured to engage internal threads of the forward shaft with external threads of the tie rod.

Clause 3. The turbofan engine according to any preceding clause, further comprising a plurality of compressor stages, wherein at least one compressor stage comprises a first type of disk, and a second compressor stage comprises a second type of disk.

Clause 4. The turbofan engine according to any preceding clause, wherein the forward shaft comprises an alloy configured to improve low cycle fatigue at thread fillets.

Clause 5. The turbofan engine according to any preceding clause, wherein the thread engagement is coupled to the tie rod assembly.

Clause 6. The turbofan engine according to any preceding clause, wherein the forward shaft is integral with the blisk as a one piece, monolithic component.

Clause 7. The turbofan engine according to any preceding clause, wherein the forward shaft is integral with the tie rod assembly as a one piece, monolithic component.

Clause 8. The turbofan engine according to any preceding clause, wherein the tie rod assembly is welded together with the blisk as a one piece component.

Clause 9. The turbofan engine according to any preceding clause, wherein clamping of the tie rod assembly into a plurality of loops reduces an effective span of the tie rod assembly.

Clause 10. The turbofan engine according to any preceding clause, wherein the plurality of loops comprises three loops.

Clause 11. A gas turbine engine, comprising: a tie rod assembly; a forward shaft; a blisk; a thread engagement coupled to a cone shaft of the blisk; a first coupling nut and a second coupling nut; and a compressor rotor, wherein the first coupling nut is coupled to a cone shaft of the compressor rotor, and the second coupling nut is coupled to the forward shaft.

Clause 12. The gas turbine engine according to any preceding clause, further comprising a turbine rotor, and a third coupling nut coupled to an aft end stage of the turbine rotor.

Clause 13. The gas turbine engine according to any preceding clause, wherein the forward shaft comprises an alloy configured to improve low cycle fatigue at thread fillets.

Clause 14. The gas turbine engine according to any preceding clause, further comprising a thread engagement coupled to a cone shaft of the blisk.

Clause 15. The gas turbine engine according to any preceding clause, wherein the thread engagement is coupled to the tie rod assembly.

Clause 16. The gas turbine engine according to any preceding clause, wherein the forward shaft is integral with the blisk as a one piece, monolithic component.

Clause 17. The gas turbine engine according to any preceding clause, wherein the forward shaft is integral with the tie rod assembly as a one piece, monolithic component.

Clause 18. The gas turbine engine according to any preceding clause, wherein the tie rod assembly is welded together with the blisk as a one piece component.

Clause 19. The gas turbine engine according to any preceding clause, wherein clamping of the tie rod assembly into a plurality of loops reduces an effective span of the tie rod assembly.

Clause 20. The gas turbine engine according to any preceding clause, wherein the plurality of loops comprises three loops.

We claim:

1. A turbofan engine, comprising:
a tie rod assembly;
a plurality of coupling nuts;
a forward shaft;
a blisk;
a thread engagement coupled to a cone shaft of the blisk;
a high pressure compressor rotor; and
a high pressure turbine rotor comprising a cone shaft, wherein a first coupling nut is coupled to the cone shaft of the high pressure compressor rotor, a second coupling nut is coupled to the forward shaft, and a third coupling nut is coupled to an aft end stage of the high pressure turbine rotor.

2. The turbofan engine of claim 1, wherein the thread engagement is configured to engage internal threads of the forward shaft with external threads of the tie rod assembly.

3. The turbofan engine of claim 1, further comprising a plurality of compressor stages, wherein at least one compressor stage comprises a first type of disk, and a second compressor stage comprises a second type of disk.

4. The turbofan engine of claim 1, wherein the forward shaft comprises an alloy configured to improve low cycle fatigue at thread fillets.

5. The turbofan engine of claim 1, wherein the thread engagement is coupled to the tie rod assembly.

6. The turbofan engine of claim 1, wherein the forward shaft is integral with the blisk as a one piece, monolithic component.

7. The turbofan engine of claim 1, wherein the forward shaft is integral with the tie rod assembly as a one piece, monolithic component.

8. The turbofan engine of claim 1, wherein the tie rod assembly is welded together with the blisk as a one piece component.

9. The turbofan engine of claim 1, wherein clamping of the tie rod assembly into a plurality of loops reduces an effective span of the tie rod assembly.

10. The turbofan engine of claim 9, wherein the plurality of loops comprises three loops.

11. A gas turbine engine, comprising:
a tie rod assembly;
a forward shaft;
a blisk;
a thread engagement coupled to a cone shaft of the blisk;
a first coupling nut and a second coupling nut; and
a compressor rotor, wherein the first coupling nut is coupled to a cone shaft of the compressor rotor, and the second coupling nut is coupled to the forward shaft.

12. The gas turbine engine of claim 11, further comprising a turbine rotor, and a third coupling nut coupled to an aft end stage of the turbine rotor.

13. The gas turbine engine of claim 11, wherein the forward shaft comprises an alloy configured to improve low cycle fatigue at thread fillets.

14. The gas turbine engine of claim 11, further comprising a thread engagement coupled to a cone shaft of the blisk.

15. The gas turbine engine of claim 14, wherein the thread engagement is coupled to the tie rod assembly.

16. The gas turbine engine of claim 11, wherein the forward shaft is integral with the blisk as a one piece, monolithic component.

17. The gas turbine engine of claim 11, wherein the forward shaft is integral with the tie rod assembly as a one piece, monolithic component.

18. The gas turbine engine of claim 11, wherein the tie rod assembly is welded together with the blisk as a one piece component.

19. The gas turbine engine of claim 11, wherein clamping of the tie rod assembly into a plurality of loops reduces an effective span of the tie rod assembly.

20. The gas turbine engine of claim 19, wherein the plurality of loops comprises three loops.
